(19) United States
(12) Patent Application Publication
(10) Pub. No.: US 2024/0314681 A1
(43) Pub. Date: Sep. 19, 2024

(54) USER EQUIPMENT OPERATION IN MOBILITY SCENARIOS

(71) Applicant: QUALCOMM Incorporated, San Diego, CA (US)

(72) Inventors: Victor KULIK, San Jose, CA (US); Junsheng HAN, Los Altos Hills, CA (US); Arvind Vardarajan SANTHANAM, San Diego, CA (US); Justin MCGLOIN, Los Altos, CA (US); Rashmi KULKARNI, Redwood City, CA (US); Shanshan WANG, San Diego, CA (US); Osama LOTFALLAH, San Diego, CA (US)

(21) Appl. No.: 18/184,464

(22) Filed: Mar. 15, 2023

(51) Int. Cl. H04W 48/20; H04W 8/12; H04W 64/00

(52) U.S. Cl. CPC H04W 48/20; H04W 8/12; H04W 64/006

(57) ABSTRACT

In mobility scenarios, a user equipment (UE) may enter an airplane mod in which the UE has limited or no connectivity to a network. Cell selection latency after terminating the airplane mode may result in a delay in providing network or communication services. Some aspects described herein enable a reduction in latency associated with cell selection after operation in a mobility scenario. For example, a UE may determine that the UE is operating in a mobility scenario, and perform a receive-only cell selection procedure. Additionally, or alternatively, the UE may predict a destination associated with the mobility scenario and may identify a band list for performing a cell selection procedure. In this way, when the UE exits the mobility scenario, the UE reduces a time to successfully complete cell selection.

### FIELD OF THE DISCLOSURE

Aspects of the present disclosure generally relate to wireless communication and to techniques and apparatuses for user equipment operation in mobility scenarios.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. 5G, which may be referred to as New Radio (NR), is a set of enhancements to the LTE mobile standard promulgated by the 3GPP. 5G is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in 4G, 5G, and other radio access technologies remain useful.

### SUMMARY

In mobility scenarios, a user equipment (UE) may enter a mobility mode in which the UE has limited or no connectivity to a network. For example, when a UE is being operated on an aircraft (e.g., an airplane), the UE may operate in an “airplane mode” in which the UE is not connected to a cellular network, but in which the UE remains on and can use local area network (LAN) connections, such as Wi-Fi connections or Bluetooth connections. When the mobility scenario ends, the UE may transition out of the mobility mode to a normal operating mode. For example, when an aircraft lands at a destination, the UE may exit the airplane mode and may attempt to connect to a cellular network at the destination. Cell selection latency may result in a delay in providing network or communication services. For example, cell selection latency after an aircraft lands may result in a wait of two minutes or longer before a cellular connection is established.

Similar mobility modes and cell connection scenarios may exist in connection with operation in other mobility scenarios, such as operation in a vehicle, operation on a train, or operation on a ship, among other examples. For example, when operating on a ship in an area with limited or no cellular coverage, a user may cause a UE to enter an airplane mode to reduce usage of power resources associated with attempting to identify cellular connections in areas with no connectivity (e.g., while traveling on the ocean). In this case, when the ship arrives in port, the user may cause the UE to exit the airplane mode and attempt to acquire a cellular connection in a port. Additionally, or alternatively, when traveling at high speeds on a train, repeated handovers between different cells may result in an excessive utilization of power resources, so a user may use the airplane mode until the train is stopped at a station to avoid draining power from a UE.

Some aspects described herein enable a reduction in latency associated with cell selection after operation in a mobility scenario. For example, a UE may determine that the UE is operating in a mobility scenario (e.g., based at least in part on determining that an airplane mode is active), and perform a receive-only cell selection procedure (e.g., a receive-only search). In this way, when the UE exits the mobility scenario (e.g., turns off the airplane mode), the UE reduces a time to complete a receive and transmit cell selection procedure. Additionally, or alternatively, the UE may predict a destination associated with the mobility scenario (e.g., based at least in part on sensor data from sensors of the UE or positioning data from a satellite) and may identify a band list for performing a cell selection procedure. In this way, when the UE exits the mobility scenario, the UE reduces a time to successfully select a band for cell selection, by identifying bands that can be used for cell selection at a destination where the UE is operating.

Some aspects described herein relate to a method of wireless communication performed by a UE. The method may include receiving sensor data or other data associated with identifying a characteristic associated with a mobility scenario. The method may include performing at least a portion of a cell selection procedure based at least in part on the characteristic associated with the mobility scenario.

Some aspects described herein relate to a UE for wireless communication. The UE may include a memory and one or more processors coupled to the memory. The one or more processors may be configured to receive sensor data or other data associated with identifying a characteristic associated with a mobility scenario. The one or more processors may be configured to perform at least a portion of a cell selection procedure based at least in part on the characteristic associated with the mobility scenario.

Some aspects described herein relate to a non-transitory computer-readable medium that stores a set of instructions for wireless communication by a UE. The set of instructions, when executed by one or more processors of the UE, may cause the UE to receive sensor data or other data associated with identifying a characteristic associated with a mobility scenario. The set of instructions, when executed by one or more processors of the UE, may cause the UE to perform at least a portion of a cell selection procedure based at least in part on the characteristic associated with the mobility scenario.

Some aspects described herein relate to an apparatus for wireless communication. The apparatus may include means for receiving sensor data or other data associated with identifying a characteristic associated with a mobility scenario. The apparatus may include means for performing at least a portion of a cell selection procedure based at least in part on the characteristic associated with the mobility scenario.

Aspects generally include a method, apparatus, system, computer program product, non-transitory computer-readable medium, user equipment, base station, wireless communication device, network entity, network node, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

FIG. 1 is a diagram illustrating an example of a wireless network.

FIG. 2 is a diagram illustrating an example of a network node in communication with a user equipment (UE) in a wireless network.

FIG. 3 is a diagram illustrating an example disaggregated base station architecture, in accordance with the present disclosure.

FIG. 4 is a diagram illustrating an example of a regenerative satellite deployment and an example of a transparent satellite deployment in a non-terrestrial network.

FIGS. 5A and 5B are diagrams of an example associated with UE operation in mobility scenarios, in accordance with the present disclosure.

FIG. 6 is a flowchart of an example method of wireless communication.

FIG. 7 is a diagram of an example apparatus for wireless communication, in accordance with the present disclosure.

FIG. 8 is a diagram illustrating an example of a hardware implementation for an apparatus employing a processing system, in accordance with the present disclosure.

### DETAILED DESCRIPTION

The detailed description set forth below in connection with the appended drawings is intended as a description of various configurations and is not intended to represent the configurations in which the concepts described herein may be practiced. The detailed description includes specific details for the purposes of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, or the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, or the like, whether referred to as software, firmware, middleware, microcode, hardware description language, or otherwise.

Accordingly, in one or more example embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), compact disk ROM (CD-ROM) or other optical disk storage, magnetic disk storage or other magnetic storage devices, combinations of the aforementioned types of computer-readable media, or any other medium that can be used to store computer executable code in the form of instructions or data structures that can be accessed by a computer.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

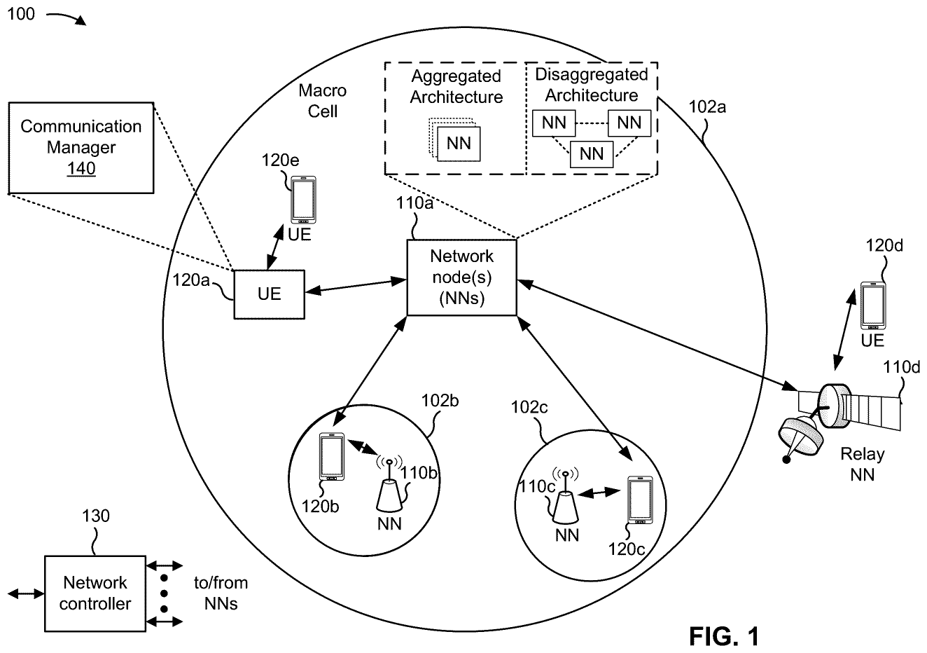

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHZ-7.125 GHZ) and FR2 (24.25 GHZ-52.6 GHZ). Although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ.-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHZ. For example, three higher operating bands have been identified as frequency range designations FR4a or FR4-1 (52.6 GHZ-71 GHZ), FR4 (52.6 GHZ.-114.25 GHZ), and FR5 (114.25 GHZ.-300 GHz). Each of these higher frequency bands falls within the EHF band.

With these examples in mind, unless specifically stated otherwise, the term “sub-6 GHz,” if used herein, may broadly represent frequencies that may be less than 6 GHZ, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive sensor data or other data associated with identifying a characteristic associated with a mobility scenario; and perform at least a portion of a cell selection procedure based at least in part on the characteristic associated with the mobility scenario. Additionally, or alternatively, the communication manager 140 may perform one or more other operations described herein.

As indicated above, FIG. 1 is provided as an example. Other examples may differ from what is described with regard to FIG. 1.

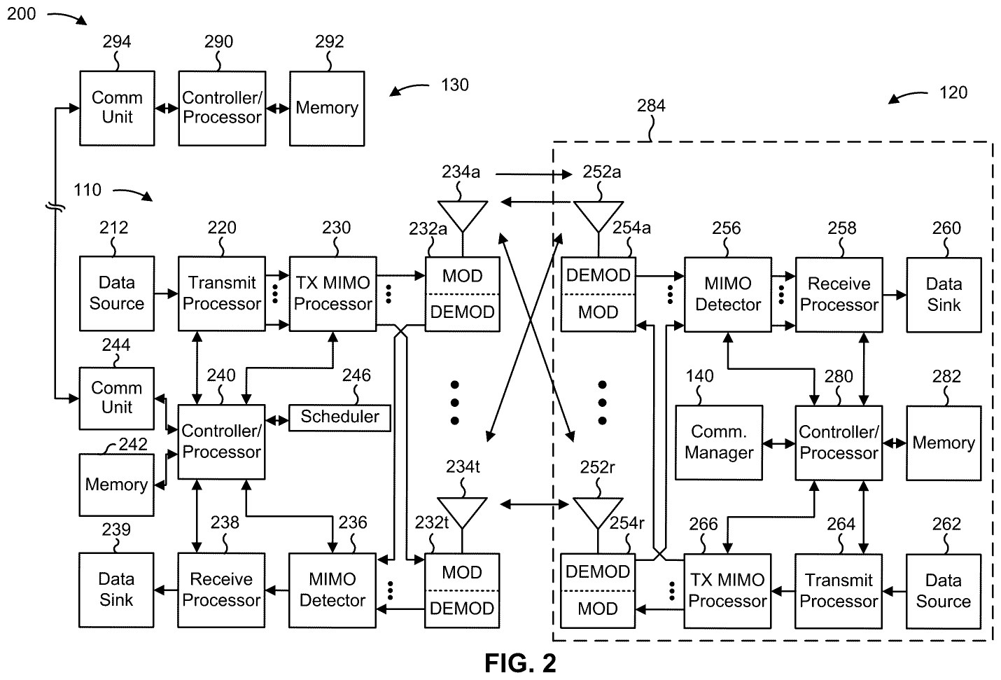

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive (RX) processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a

controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein.

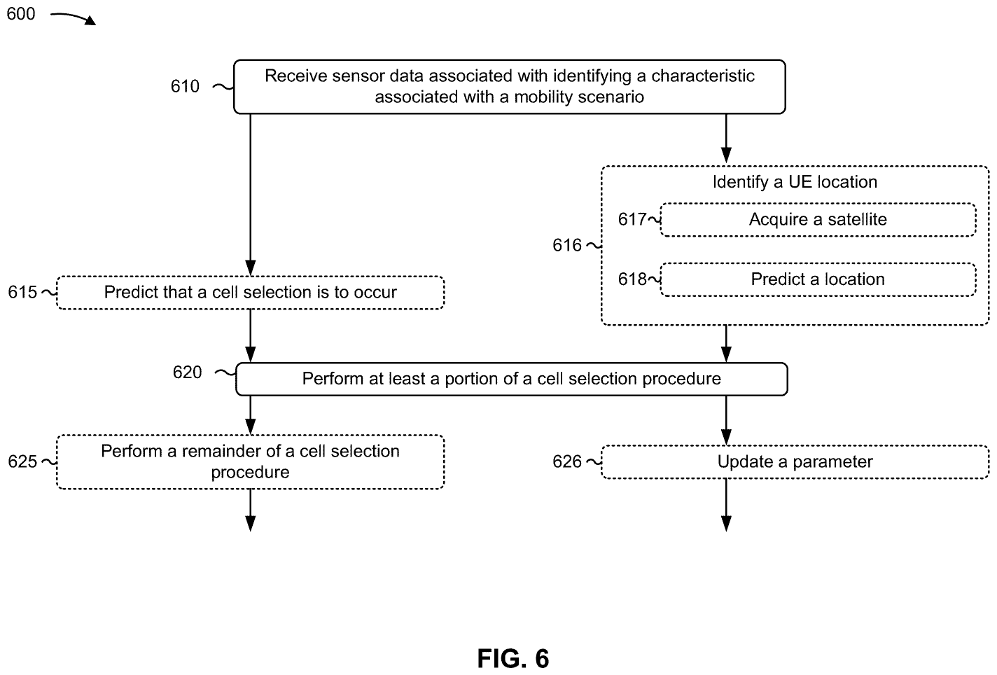

The controller/processor 240 of the network node 110, the controller/processor 280 of the UE 120, and/or any other component(s) of FIG. 2 may perform one or more techniques associated with UE operation in mobility scenarios, as described in more detail elsewhere herein. For example, the controller/processor 240 of the network node 110, the controller/processor 280 of the UE 120, and/or any other component(s) of FIG. 2 may perform or direct operations of, for example, method 600 of FIG. 6 and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, method 600 of FIG. 6 and/or other processes as described herein. In some examples, executing instructions may include running the instructions, converting the instructions, compiling the instructions, and/or interpreting the instructions, among other examples.

In some aspects, a UE (e.g., the UE 120) includes means for receiving sensor data or other data associated with identifying a characteristic associated with a mobility scenario; and/or means for performing at least a portion of a cell selection procedure based at least in part on the characteristic associated with the mobility scenario. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network. a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

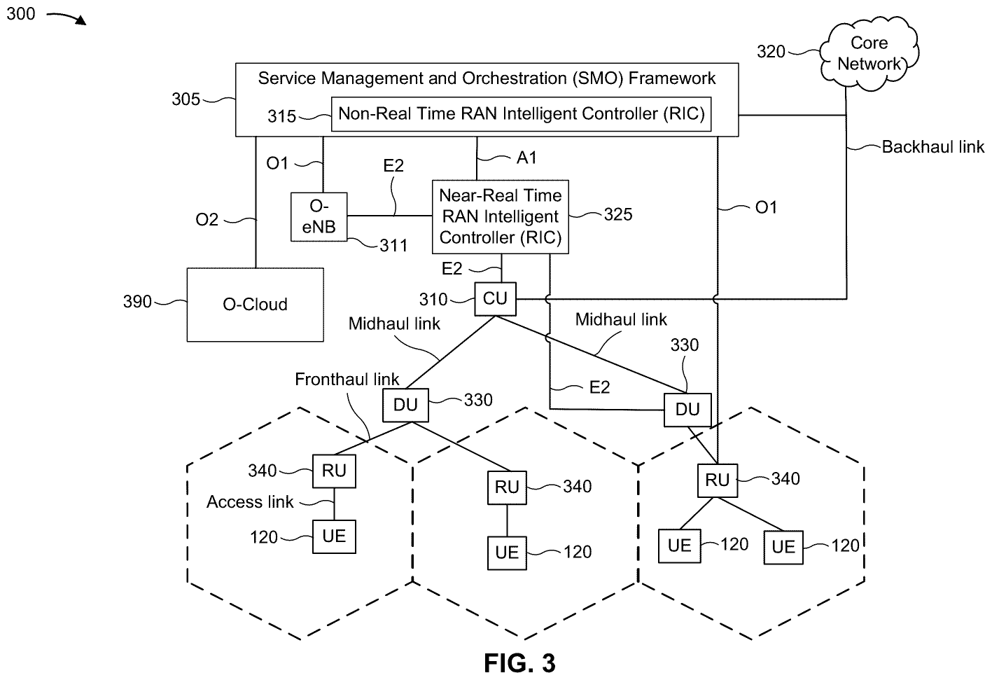

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

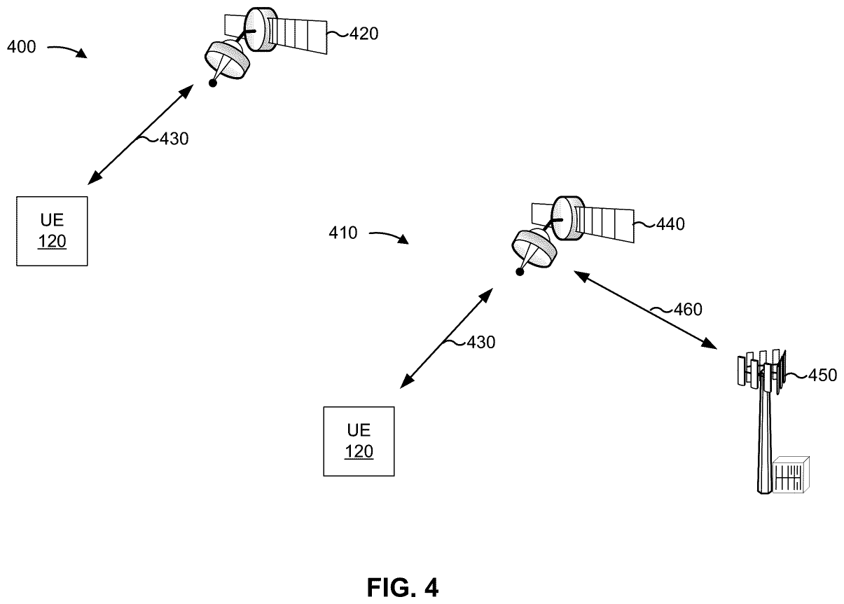

FIG. 4 is a diagram illustrating an example 400 of a regenerative satellite deployment and an example 410 of a transparent satellite deployment in a non-terrestrial network.

Example 400 shows a regenerative satellite deployment. In example 400, a UE 120 is served by a satellite 420 via a service link 430. For example, the satellite 420 may include a network node 110 (e.g., network node 110a) or a gNB. In some aspects, the satellite 420 may be referred to as a non-terrestrial base station, a regenerative repeater, or an on-board processing repeater. In some aspects, the satellite 420 may demodulate an uplink radio frequency signal, and may modulate a baseband signal derived from the uplink radio signal to produce a downlink radio frequency transmission. The satellite 420 may transmit the downlink radio frequency signal on the service link 430. The satellite 420 may provide a cell that covers the UE 120.

Example 410 shows a transparent satellite deployment, which may also be referred to as a bent-pipe satellite deployment. In example 410, a UE 120 is served by a satellite 440 via the service link 430. The satellite 440 may be a transparent satellite. The satellite 440 may relay a signal received from gateway 450 via a feeder link 460. For example, the satellite may receive an uplink radio frequency transmission, and may transmit a downlink radio frequency transmission without demodulating the uplink radio frequency transmission. In some aspects, the satellite may frequency convert the uplink radio frequency transmission received on the service link 430 to a frequency of the uplink radio frequency transmission on the feeder link 460, and may amplify and/or filter the uplink radio frequency transmission. In some aspects, the UEs 120 shown in example 400 and example 410 may be associated with a Global Navigation Satellite System (GNSS) capability or a Global Positioning System (GPS) capability, though not all UEs have such capabilities. The satellite 440 may provide a cell that covers the UE 120.

The service link 430 may include a link between the satellite 440 and the UE 120, and may include one or more of an uplink or a downlink. The feeder link 460 may include a link between the satellite 440 and the gateway 450, and may include one or more of an uplink (e.g., from the UE 120 to the gateway 450) or a downlink (e.g., from the gateway 450 to the UE 120).

The feeder link 460 and the service link 430 may each experience Doppler effects due to the movement of the satellites 420 and 440, and potentially movement of a UE 120. These Doppler effects may be significantly larger than in a terrestrial network. The Doppler effect on the feeder link 460 may be compensated for to some degree, but may still be associated with some amount of uncompensated frequency error. Furthermore, the gateway 450 may be associated with a residual frequency error, and/or the satellite 420/440 may be associated with an on-board frequency error. These sources of frequency error may cause a received downlink frequency at the UE 120 to drift from a target downlink frequency.

As indicated above, FIG. 4 is provided as an example. Other examples may differ from what is described with regard to FIG. 4.

In mobility scenarios, a UE may enter a mobility mode in which the UE has limited or no connectivity to a network. For example, when a UE is being operated on an aircraft (e.g., an airplane), the UE may operate in an “airplane mode” (“APM”) in which the UE is not connected to a cellular network, but in which the UE remains on and can use local area network (LAN) connections, such as Wi-Fi connections or Bluetooth connections. When the mobility scenario ends, the UE may transition out of the mobility mode to a normal operating mode. For example, when an aircraft lands at a destination, the UE may exit the airplane mode and may attempt to connect to a cellular network at the destination. Cell selection latency may result in a delay in providing network or communication services. For example, cell selection latency after an aircraft lands may result in a wait of two minutes or longer before a cellular connection is established.

Similar mobility modes and cell connection scenarios may exist in connection with operation in other mobility scenarios, such as operation in a vehicle, operation on a train, or operation on a ship, among other examples. For example, when operating on a ship in an area with limited or no cellular coverage, a user may cause a UE to enter an airplane mode to reduce usage of power resources associated with attempting to identify cellular connections in areas with no connectivity (e.g., while traveling on the ocean). In this case, when the ship arrives in port, the user may cause the UE to exit the airplane mode and attempt to acquire a cellular connection in a port. Additionally, or alternatively, when traveling at high speeds on a train or in a vehicle, repeated handovers between different cells may result in an excessive utilization of power resources, so a user may use the airplane mode until the train or the vehicle is stopped to avoid draining power from a UE. In these examples, when the airplane mode (or another type of mobility mode) is deactivated, there may be an excess latency associated with identifying a set of bands for a cell selection procedure and performing the cell selection procedure.

Some implementations described herein provide techniques for UE operation in connection with a mobility scenario. For example, a UE may determine that the UE is operating in a mobility scenario (e.g., based at least in part on determining that an airplane mode is active), and perform a receive-only cell selection procedure (e.g., a receive-only search). In the receive-only cell selection procedure, the UE turns on an antenna and monitors for one or more signals associated with a cell selection procedure, thereby enabling the UE to perform some operations of the cell selection procedure (e.g., receiving a system information block (SIB)) without transmitting (e.g., which may be restricted in connection with the mobility scenario). In this way, when the UE exits the mobility scenario (e.g., turns off the airplane mode), the UE reduces a time to complete a receive and transmit cell selection procedure (e.g., by having already performed one or more steps of the cell selection procedure).

Additionally, or alternatively, the UE may predict a destination associated with the mobility scenario (e.g., based at least in part on sensor data from sensors of the UE or positioning data from a satellite) and may identify a band list for performing a cell selection procedure. For example, when the UE predicts a first destination associated with a mobility scenario the UE may select a first list of bands that are used by network nodes in the first destination, and may select a second list of bands that are used by network nodes in a second destination when the second destination is predicted. In some aspects, the UE may use incomplete location information associated with one or more navigation satellites to predict the destination. For example, when a set of 4 satellites is required for location determination using a navigation satellite system, the UE may use fewer than the set of 4 satellites (e.g., 1 to 3 satellites) to estimate the location (e.g., in connection with other sensor data) and obtain a band list, thereby reducing an amount of time to obtain the band list relative to acquiring the complete set of 4 satellites. In this way, when the UE exits the mobility scenario, the UE reduces a time to successfully select a band for cell selection, thereby improving UE performance and reducing a communication delay.

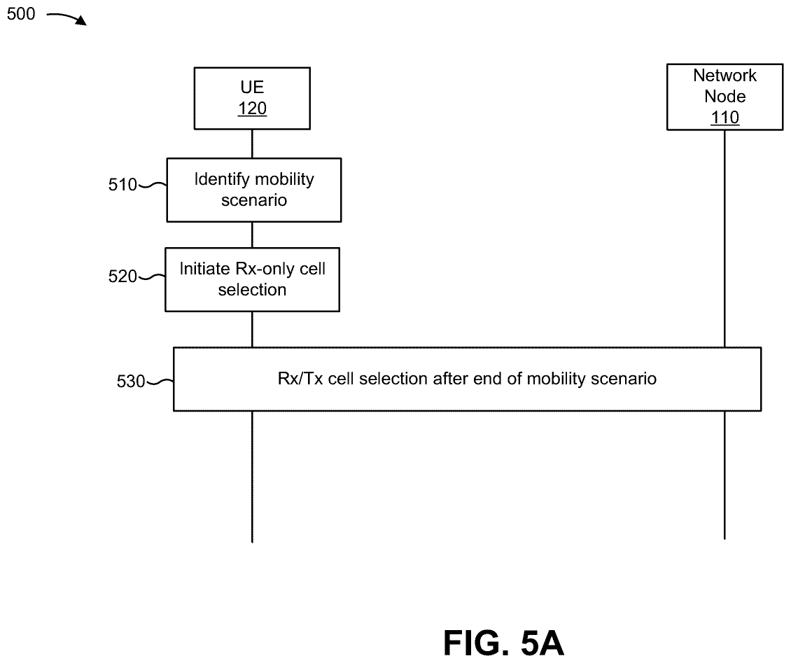

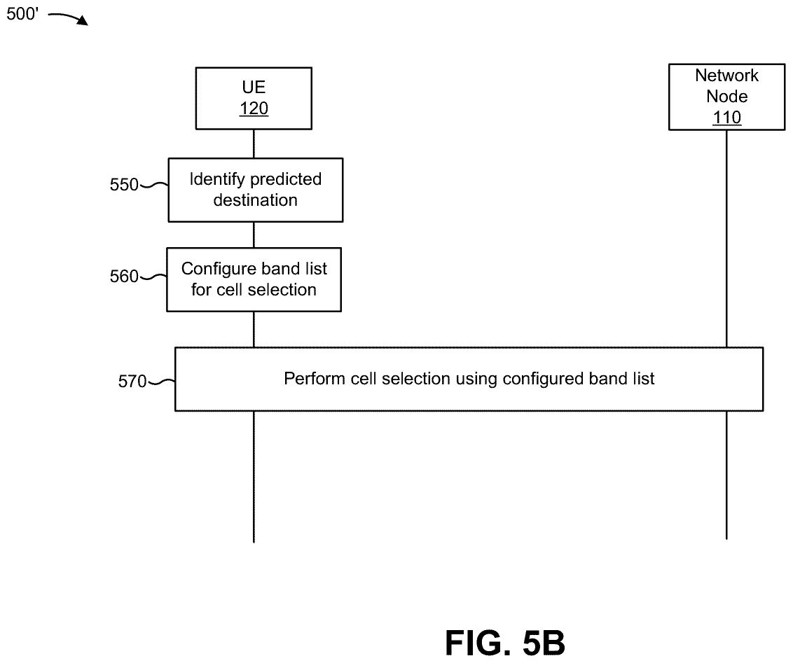

FIGS. 5A and 5B are diagrams of examples 500/500′ associated with UE operation in mobility scenarios, in accordance with the present disclosure. As shown in FIGS. 5A and 5B, a UE 120 may communicate with a network node 110, among other devices. Although some aspects are described herein in terms of UE operation in mobility scenarios, it is contemplated that network nodes may similarly operate in mobility scenarios. For example, an RU may perform operations of examples 500/500′ to connect with a CU or a DU in connection with a mobility scenario.

At 510, the UE 120 may identify a mobility scenario. For example, the UE 120 may receive an indication and determine a characteristic of the mobility scenario, such as whether the UE 120 is operating in the mobility scenario, whether the UE 120 has activated an airplane mode associated with the mobility scenario, and/or whether the UE 120 is at a particular phase of the mobility scenario, as described below.

In some aspects, the UE 120 may determine that the UE 120 is in the mobility scenario based at least in part on the received indication. In this case, the received indication may include sensor data or other data, such as information indicating a status of the UE (e.g., that a cellular antenna or modem is turned off). As an example of other data, data identifying a mode the UE (e.g., data from a modem or data from an application) may be included as other data, which indicates the status of the UE. In other words, when the UE is transitioned to airplane mode, the UE 120 may receive (e.g., at a first component, such as a processor, and from a second component, such as a modem) data indicating, for example, initiation or completion of the transition. Additionally, or alternatively, the received indication may include other sensor data, such as accelerometer data or barometric pressure data that may indicate that the UE 120 is being operated in a mobility scenario (e.g., accelerometer data identifying a speed of the UE 120 or barometric pressure data identifying an altitude of the UE 120). Additionally, or alternatively, the UE 120 may receive geofencing data indicating that the UE 120 is operating in a mobility scenario, such as in an aircraft, a ship, a train, or a car. Additionally, or alternatively, the UE 120 may determine that the UE 120 is in a mobility scenario based at least in part on identifying a Wi-Fi network. For example, when the UE 120 detects a Wi-Fi network associated with an aircraft (e.g., which the UE 120 may determine based at least in part on a pre-configured list, one or more previous instances using the Wi-Fi network, or by parsing a name of the Wi-Fi network), the UE 120 may determine that the UE 120 is on an aircraft.

In some aspects, the UE 120 may determine that the UE 120 has activated an airplane mode associated with the mobility scenario. For example, the UE 120 may determine that the UE 120 has activated the airplane mode based at least in part on a received indication from an application (which may be sent from the application based at least in part on an indication that an antenna or modem is off). Although some aspects are described in terms of using sensor data to identify the mobility scenario and determine whether to perform a receive-only cell selection procedure, it is contemplated that some UEs 120 may identify the mobility scenario without sensor data (e.g., using only an indication that the airplane mode is activated) and perform the receive-only cell selection procedure without sensor data (e.g., periodically when the airplane mode is activated).

In some aspects, the UE 120 may determine a particular phase of the mobility scenario. For example, the UE 120 may predict whether the mobility scenario will end within a threshold amount of time based at least in part on sensor data. In this way, the UE 120 may reduce power utilization by performing the receive-only cell selection procedure, as described below, only when the UE 120 is predicted to have the airplane mode turned off within a threshold period of time (e.g., at a destination). In some aspects, the UE 120 may determine the particular phase of the mobility scenario based at least in part on sensor data from one or more sensors. For example, the UE 120 may use accelerometer data to identify a landing sequence or descent phase of an aircraft. In this case, the UE 120 may have a model of aircraft landing sequences and compare accelerometer data with the model to predict whether an aircraft landing sequence is occurring. For example, accelerometer data identifying a descent, a serious of turns, a vibration associated with lowering or extension of a landing gear, a vibration associated with wheels touching down, or other types of actions as correlating with an airplane mode being deactivated within a threshold period of time. Additionally, or alternatively, the UE 120 may use barometric pressure data to identify (e.g., using a model) a change in cabin pressure associated with a landing sequence or landing phase. Additionally, or alternatively, the UE 120 may use humidity data (e.g., identifying an atmospheric change associated with an altitude change), location data (e.g., from a satellite as described below), user data (e.g., information identifying a flight reservation and an associated timing of the flight), among other examples to predict when an airplane mode is likely to be turned off and a cell selection procedure is to occur.

In some aspects, the UE 120 may acquire contextual data to assist in location determination and/or prediction of a characteristic of a mobility scenario (e.g., prediction of when and/or where an aircraft flight will end). For example, when the UE 120 detects that the UE 120 is being operated at an airport (e.g., based at least in part on location data, geofencing data, or Wi-Fi network data), the UE 120 may access an application server storing flight data (e.g., departure times, flight durations, aircraft types, aircraft speeds, aircraft cruising altitudes, aircraft flight paths, models of sensor data for specific aircrafts, weather data for destinations of aircraft, etc.). In this case, the UE 120 may use the flight data in connection with timing or sensor data during the airplane mode to predict a destination and/or whether the UE 120 is within a threshold period of time of arriving at the destination and performing a cell selection. For example, the UE 120 may use departure time information with information identifying when an airplane mode was activated to predict which flight, of a set of flights, the UE 120 is being operated on. Based at least in part on predicting the flight, the UE 120 may predict a UE location (or destination), a UE destination (e.g., and a set of associated bands for a country of the UE destination, as described below), and/or whether the airplane mode is predicted to be terminated within a threshold period of time. In some aspects, the UE 120 may predict the UE location, the UE destination, and/or whether the airplane mode is predicted to be terminated within the threshold period of time based at least in part on sensor data, as described below at 550.

Additionally, or alternatively, the UE 120 may receive data from another application, such as an airline application (e.g., a reservation or flight alert), calendar application (e.g., a calendar appointment), a search application (e.g., a search history), or an email application (e.g., a confirmation email), which may indicate which flight a user of the UE 120 is to be on and/or one or more other details of the flight (e.g., duration, direction, destination, etc.). Additionally, or alternatively, the UE 120 may opportunistically obtain other information, such as monitoring in-flight announcements using a microphone (e.g., announcements identifying a destination, a local time (from which the UE 120 may identify a time zone or a language of announcements or other language observed on the aircraft (from which the UE 120 may infer a destination)), or a temperature (from which the UE 120 may infer a location)), a camera (e.g., a displayed flight path on a video screen within an aircraft), a Wi-Fi connection (e.g., which may be configured to provide location information to UEs even when the UEs have not paid for access to communication services via the Wi-Fi connection), or a sidelink connection (e.g., another UE 120 may transmit sidelink broadcasts over a licensed band or a V2X band identifying a location or sensor data to enable improved location determination).

At 520, the UE 120 may initiate a receive-only cell selection procedure. For example, the UE 120 may perform a cell selection procedure while the UE 120 remains in airplane mode (e.g., and is prohibited from transmission). In this case, the UE 120 can prepare for a termination of the airplane mode at a predicted time and when the UE 120 is predicted to have had a location change from a last successful cell selection. In some aspects, the UE 120 may determine to initiate the receive-only cell selection procedure based at least in part on the UE 120 being in a mobility scenario. For example, when the UE 120 determines that a mobility scenario is occurring, the UE 120 may perform a receive-only cell selection procedure. Additionally, or alternatively, when the UE 120 predicts that the mobility scenario is within a threshold period of ending, the UE 120 may perform the receive-only cell selection procedure. Additionally, or alternatively, when the UE 120 determines that a distance or amount of time since a last successful cell selection is greater than a threshold amount of distance or time, the UE 120 may perform the receive-only cell selection procedure.

In some aspects, when performing the receive-only cell selection procedure, the UE 120 may attempt to receive one or more cell selection procedure signals from a network node 110. For example, the UE 120 may tune an antenna and associated modem to a particular band (e.g., of a band list as described below) and may attempt to receive one or more signals associated with cell selection, such as a signal identifying a synchronization signal block (SSB), an SIB, a master information block (MIB), or another signal that various network nodes 110 may periodically transmit to enable UEs 120 to perform cell selection. In this case, the UE 120 may parse received information of the receive-only cell selection procedure, in advance of termination of the airplane mode, to enable the UE 120 to complete the cell selection procedure when the airplane mode is terminated. For example, the UE 120 may identify one or more available cells at a predicted destination to enable camping onto the one or more available cells. In some aspects, the UE 120 may perform the receive-only cell selection until the UE 120 is RRC camped onto a cell.

In some aspects, the UE 120 may update one or more parameters in connection with performing the receive-only cell selection procedure. For example, the UE 120 may map a detected signal mobile country code (MCC) to a location (e.g., using a table of MCCs and locations) and update a location of the UE 120 for location services. In this case, the UE 120 may update a band list based at least in part on the UE location and/or a prediction of a future UE location (destination) (e.g., based at least in part on an observed travel path of the UE 120, as described below). Additionally, or alternatively, the UE 120 may adjust a UE clock time zone to a local time based at least in part on determining a location using the receive-only cell selection procedure. Additionally, or alternatively, the UE 120 may predict and/or adjust to a communication satellite azimuth and elevation for an emergency satellite communications service. For example, when the UE 120 implements satellite-based emergency (SOS) texting, the UE 120 may use a determined location to adjust a satellite azimuth and elevation for transmitting the emergency texting. Additionally, or alternatively, when the UE 120 implements other (non-emergency) satellite communication services, the UE 120 may update a satellite azimuth and elevation for the other satellite communication services based on a determined location. Additionally, or alternatively, the UE 120 may update a magnetic compass declination based at least in part on a determined location, thereby maintaining accurate compass readings while in airplane mode. Additionally, or alternatively, the UE 120 may update a country-level seed position for navigation system signal searching (e.g., GPS, GNSS, or another navigation system), thereby enabling satellite acquisition for satellite-based positioning.

At 530, the UE 120 may perform a cell selection procedure (e.g., a receive and transmit cell selection procedure). For example, the UE 120 may transmit and/or receive one or more communications associated with selecting a cell for communications services. In some aspects, the UE 120 may perform a remainder of a cell selection procedure. For example, the UE 120 may perform a first one or more steps of the cell selection procedure (e.g., by detecting a signal and parsing the signal) in an airplane mode and a second one or more steps of the cell selection procedure once the airplane mode is terminated (e.g., by transmitting and/or receiving one or more additional signals). In this case, performing the first one or more steps of the cell selection procedure before termination of the airplane mode reduces an amount of time to complete the cell selection procedure once the airplane mode is terminated.

Additionally, or alternatively, the UE 120 may perform a new cell selection procedure. For example, the UE 120 may perform a first, receive-only cell selection procedure in an airplane mode and may perform a second, receive and transmit cell selection procedure once the airplane mode is terminated. In this case, information from the first, receive-only cell selection procedure may reduce an amount of latency associated with performing the second cell selection procedure by, for example, providing the UE 120 with a limited set of bands predicted to be successful for the second cell selection procedure (e.g., based at least in part on a location of the second cell selection procedure).

At 550, in the example 500′ shown in FIG. 5B, the UE 120 may identify a predicted destination. For example, the UE 120 may determine a characteristic of a mobility scenario, such as a mobility scenario phase, a location, or a predicted destination associated with the mobility scenario. In some aspects, the UE 120 may determine the mobility scenario phase based at least in part on sensor data, such as navigation system data (e.g., GNSS data), accelerometer data, gyroscope data, magnetometer data, barometer data, audio data (e.g., sound associated with an aircraft landing phase), etc. For example, the UE 120 may use sensor data to determine a phase of a mobility scenario, such as whether an aircraft is in a take-off phase, an ascent phase, a cruising phase, a descent phase, or a landing phase. In this case, the UE 120 may use the phase of the mobility scenario to determine a location of the UE 120 (e.g., whether the UE 120 is at a predicted destination) and/or whether to identify a band list for the UE 120 (e.g., which the UE 120 may identify when the UE 120 is predicted to be landing within a threshold period of time).

Additionally, or alternatively, the UE 120 may determine the mobility scenario location based at least in part on the sensor data. For example, based at least in part on sensor data identifying a speed and direction (e.g., and a timing for the speed and direction from a known location before the mobility scenario started), the UE 120 may estimate a current location of the UE 120.

Additionally, or alternatively, the UE 120 may determine a destination based at least in part on the sensor data. For example, based at least in part on sensor data identifying a speed and direction (e.g., and information identifying locations of airports), the UE 120 may plot locations of the UE 120 to predict an airport to which an aircraft is flying. Additionally, or alternatively, the UE 120 may use barometric pressure information (e.g., measured barometric pressure sensor data and stored weather information, such as a barometric pressure forecast for a set of locations) when the UE 120 detects that the aircraft has landed (e.g., but before the airplane mode is terminated) to determine an altitude of an airport above sea level, which may enable the UE 120 to identify a location of the airport. Additionally, or alternatively, when the UE 120 predicts that the UE 120 is in a landing phase, the UE 120 may use compass sensor data or inertial measurement unit (IMU) sensor data to determine a heading for the landing phase, compare the heading to a set of known headings for runways at a set of airports.

In some aspects, the UE 120 may use a plurality of different sensor data sources and/or non-sensor data sources to predict a set of candidate current locations or destination locations. For example, the UE 120 may use accelerometer and timing data to determine a distance traveled during a mobility phase, compass and IMU data to determine a heading for the mobility phase, barometric pressure data and weather data to determine a runway altitude, and compass and IMU data to determine a runway heading. In this case, based on the combination of data points from sensors and other data sources, the UE 120 may predict a set of possible candidate locations and/or destinations for the UE 120, thereby enabling location prediction even when any one data source is relatively inaccurate. Although described in terms of the particular combination of data sources above, other combinations of sensors and data sources are possible for feeding data into a model for predicting a location or a destination.

In some aspects, the UE 120 may approximate a location based at least in part on satellite navigation system data. For example, a satellite navigation system may use a particular quantity of acquired satellites to obtain a location fix, such as 4 or more satellites. However, the UE 120 may use fewer than the particular quantity of acquired satellites to estimate a location. For example, acquisition of and data from a single GNSS or communication satellite can limit a UE location to, for example, a hemisphere of the Earth. In this case, the UE 120 can select a band list, as described below, of bands used in countries in identified hemisphere, which may reduce a size of the band list. Additionally, or alternatively, the UE 120 may further limit an estimate of a location by predicting that edges of the identified hemisphere are more likely based at least in part on, for example, a configuration or geometry of an aircraft and windows thereof. In this case, the UE 120 may prioritize bands associated with edges of the hemisphere over bands at, for example, a center of the hemisphere. The UE 120 may use other data, such as measured satellite Doppler shift data and/or aircraft speed data (e.g., identified from accelerometer sensor data), in combination with the acquired satellite to further limit the identified hemisphere (e.g., to a subset of locations within the identified hemisphere that accords with, for example, how far the aircraft is predicted to have traveled from a starting location).

Similarly, when two satellites are acquired, the UE 120 may estimate a location as an overlap of two hemispheres determined from data associated with the two satellites, thereby enabling the UE 120 to limit a band list to bands used in countries within the overlap of the two hemispheres. Additionally, or alternatively, the UE 120 may use a delta between two concurrently tracked GNSS satellite pseudo ranges and Doppler shifts to further limit the overlap. Additionally, or alternatively, when the UE 120 acquires a plurality of satellites at different times, the UE 120 may use a trajectory approximation predicted from a sequence of observations of the plurality of satellites to predict a destination for an aircraft in which the UE 120 is located (e.g., using a great circle trajectory to identify airports in a predicted path of the UE 120 and within a predicted range of an aircraft).

Similarly, when three satellites are acquired, the UE 120 may approximate a two-dimensional location fix (e.g., a location fix without an altitude component). In this case, the UE 120 may infer the altitude based at least in part on a mobility scenario phase (e.g., an altitude in an aircraft cruising phase may be inferred to be approximately 10 kilometers (km) above sea level). In this case, even with a relatively bad geometry for the two-dimensional satellite fix (e.g., a relatively poor horizontal dilution of precision (HDoP) value), an approximation of the UE 120 location may be within several hundred kilometers, which may enable limiting of a band list to one or more countries (e.g., rather than, for example, all possible countries). In this way, the UE 120 may determine a location or destination with an acquisition of fewer than a quantity of satellites used for a location fix, which may reduce an amount of time to determine the location relative to waiting for acquisition of the quantity of satellites.

At 560, the UE 120 may configure a band list for cell selection. For example, the UE 120 may configure a band list for performing a band search associated with cell selection based at least in part on a predicted location or destination. In this case, different continents, countries, or locations within countries may have different sets of bands that are used for, for example, 5G connectivity, and the UE 120 may prioritize sets of bands associated with a predicted location or destination. Additionally, or alternatively, the UE 120 may prompt a user to provide information identifying a location of the UE 120. For example, when the airplane mode is deactivated, the UE 120 may provide a user interface element to allow a user to enter or select a location of the UE 120, which may enable the UE 120 to determine a band list and/or prioritize a set of bands thereof. In this way, the UE 120 reduces an amount of time to successfully perform the band search by reducing a quantity of bands to search (or prioritizing an order of bands to search). For example, when the UE 120 predicts that the UE 120 is in an aircraft and has landed in a particular country, the UE 120 may prioritize bands active in the particular country for performing a band search and may deprioritize bands not active in the particular country.

At 570, the UE 120 may perform cell selection using the configured band list. For example, the UE 120 may perform cell selection on one or more bands of the configured band list. In some aspects, the UE 120 may attempt to receive signals on bands of the configured band list in a prioritized order based at least in part on a prediction of a UE location or destination. In this way, an amount of time to receive signals is reduced by enabling reduction of a size of a band list or prioritization of the band list based at least in part on predicted UE location or destination.

As indicated above, FIGS. 5A and 5B is provided as an example. Other examples may differ from what is described with respect to FIGS. 5A and 5B.

FIG. 6 is a flowchart of an example method 600 of wireless communication. The method 600 may be performed by, for example, a UE (e.g., UE 120).

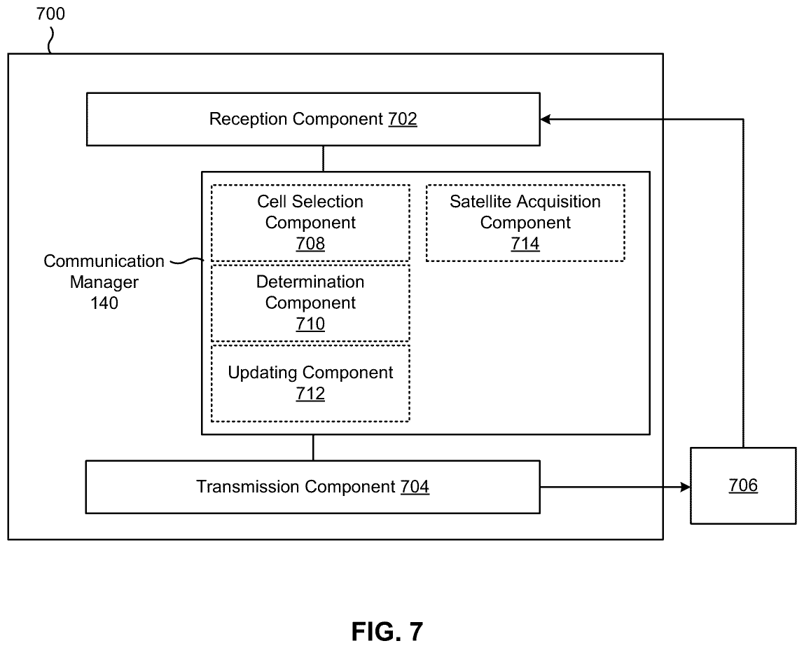

At 610, the UE may receive sensor data or other data associated with identifying a characteristic associated with a mobility scenario. For example, the UE (e.g., using communication manager 140 and/or reception component 702, depicted in FIG. 7) may receive sensor data or other data associated with identifying a characteristic associated with a mobility scenario, as described above in connection with, for example, FIGS. 5A and 5B and at 510 and 550, respectively. In some aspects, the sensor data includes information identifying a descent phase or a landing phase associated with an aircraft in which the UE is located.

In some aspects, the sensor data includes information identifying a set of pre-landing turns, a landing gear extension, a touchdown vibration, a pressure value, or a cabin pressure value change. In some aspects, receiving the sensor data includes receiving the sensor data during an airplane mode of the UE. In some aspects, the sensor data includes information identifying a change of location of the UE. In some aspects, the sensor data is from a plurality of sensors of the UE. In some aspects, the sensor data includes data from a satellite, the satellite including a navigation system satellite.

At 615, the UE may predict that cell selection is to occur. For example, the UE (e.g., using communication manager 140 and/or determination component 710, depicted in FIG. 7) may predict that sensor data indicates that cell selection is to occur, as described above in connection with, for example, FIGS. 5A and 5B and at 510 and 550, respectively. In some aspects, the UE may predict that a cell selection is to occur within a threshold period of time based at least in part on the sensor data, and the UE may perform at least a portion of a cell selection procedure based at least in part on the predicting that the cell selection is to occur. In some aspects, the predicting that the cell selection is to occur is based at least in part on whether information identifying a UE location is available and a mapping of the UE location to an associated set of available cells.

At 616, the UE may identify a UE location. For example, the UE (e.g., using communication manager 140 and/or determination component 710, depicted in FIG. 7) may determine that sensor data is associated with indicating a UE location, as described above in connection with, for example, FIGS. 5A and 5B and at 510 and 550, respectively. In some aspects, the UE may identify a UE location or a set of candidate UE locations based at least in part on the sensor data, and the UE may perform at least a portion of a cell selection procedure using a prioritized list of bands, the prioritized list of bands being based at least in part on the UE location or the set of UE locations. In some aspects, the UE location or the set of candidate UE locations is based at least in part on at least one of data associated with a Wi-Fi connection, a barometric pressure, a temperature, a travel duration, a travel distance, a departure location, or a heading. In some aspects, the UE may predict the UE location based at least in part on flight data.

At 617 and 618, to identify the UE location, the UE may acquire a satellite and predict a location. For example, the UE (e.g., using communication manager 140, satellite acquisition component 714, and/or determination component 710, depicted in FIG. 7) may acquire one or more satellites and use data received from the one or more satellites to predict a UE location of the UE. In some aspects, the UE may acquire a set of satellites, where a threshold quantity of satellites is associated with a determination of the UE location, where a quantity of satellites in the acquired set of satellites is less than the threshold quantity, and the UE may predict the UE location using the acquired set of satellites. In some aspects, the UE may acquire a plurality of satellites in a sequence, and the UE may predict the UE location based at least in part on an order of acquisition of the plurality of satellites acquired in the sequence.

At 620, the UE may perform at least a portion of a cell selection procedure. For example, the UE (e.g., using communication manager 140 and/or cell selection component 708, depicted in FIG. 7) may perform at least a portion of a cell selection procedure based at least in part on the characteristic associated with the mobility scenario, as described above in connection with, for example, FIGS. 5A and 5B and at 520 and 560, respectively. In some aspects, performing the at least the portion of the cell selection procedure includes performing a receive-only cell selection until RRC camped on a cell. For example, the UE perform a receive-based frequency or band search portion of the cell selection procedure. In this case, the UE enables receive functionality for searching frequencies or bands on a cellular RAT.

At 625, the UE may perform a remainder of the cell selection procedure. For example, the UE (e.g., using communication manager 140 and/or cell selection component 708, depicted in FIG. 7) may perform a remainder of the cell selection procedure based at least in part on performing the at least the portion of the cell selection procedure, as described above in connection with, for example, FIGS. 5A and 5B and at 530 and 570, respectively. In this case, the UE may complete the cell selection procedure to camp onto a cell and access communication services.

At 626, the UE may update a parameter. For example, the UE (e.g., using communication manager 140 and/or updating component 712, depicted in FIG. 7) may determine a value for a parameter based at least in part on performing the at least the portion of the cell selection procedure, as described above in connection with, for example, FIGS. 5A and 5B and at 520 and 560, respectively. In some aspects, the UE may update, based at least in part on performing the at least the portion of the cell selection procedure, at least one of a UE location or one or more parameters associated with the UE location. In some aspects, the one or more parameters include at least one of a UE clock time zone, a communication satellite beam information, a magnetic compass declination, or a country level seed position for signal searching.

Although FIG. 6 shows example blocks of method 600, in some aspects, method 600 may include additional blocks, fewer blocks, different blocks, or differently arranged blocks than those depicted in FIG. 6. Additionally, or alternatively, two or more of the blocks of method 600 may be performed in parallel.

FIG. 7 is a diagram of an example apparatus 700 for wireless communication, in accordance with the present disclosure. The apparatus 700 may be a UE, or a UE may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include the communication manager 140. The communication manager 140 may include one or more of a cell selection component 708, a determination component 710, an updating component 712, or a satellite acquisition component 714, among other examples.

In some aspects, the apparatus 700 may be configured to perform one or more operations described herein in connection with FIGS. 5A-5B. Additionally, or alternatively, the apparatus 700 may be configured to perform one or more processes described herein, such as method 600 of FIG. 6. In some aspects, the apparatus 700 and/or one or more components shown in FIG. 7 may include one or more components of the UE described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the UE described in connection with FIG. 2.

The transmission component 704 may transmit communications, such as reference signals, control information, data communications, or a combination thereof, to the apparatus 706. In some aspects, one or more other components of the apparatus 700 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, a memory, or a combination thereof, of the UE described in connection with FIG. 2. In some aspects, the transmission component 704 may be co-located with the reception component 702 in a transceiver.

The reception component 702 may receive sensor data or other data associated with identifying a characteristic associated with a mobility scenario. The cell selection component 708 may perform at least a portion of a cell selection procedure based at least in part on the characteristic associated with the mobility scenario. The determination component 710 may predict that a cell selection is to occur within a threshold period of time based at least in part on the sensor data. The updating component 712 may update, based at least in part on performing the at least the portion of the cell selection procedure, at least one of a UE location or one or more parameters associated with the UE location. The determination component 710 may identify a UE location or a set of candidate UE locations based at least in part on the sensor data.

The satellite acquisition component 714 may acquire a set of satellites, wherein a threshold quantity of satellites is associated with a determination of the UE location, wherein a quantity of satellites in the acquired set of satellites is less than the threshold quantity. The determination component 710 may predict the UE location using the acquired set of satellites.

The satellite acquisition component 714 may acquire a plurality of satellites in a sequence. The determination component 710 may predict the UE location based at least in part on an order of acquisition of the plurality of satellites acquired in the sequence. The determination component 710 may predict the UE location based at least in part on flight data.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

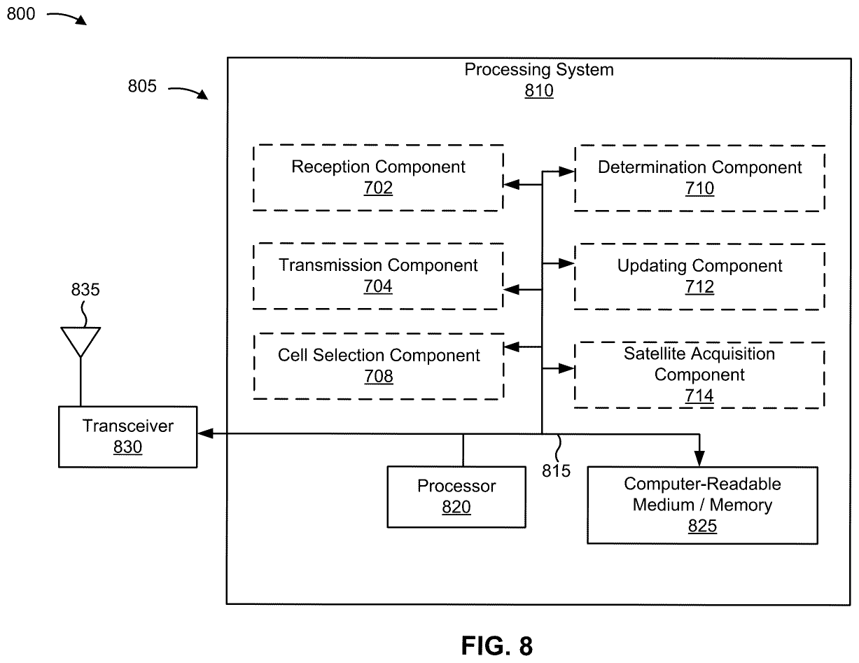

FIG. 8 is a diagram illustrating an example 800 of a hardware implementation for an apparatus 805 employing a processing system 810, in accordance with the present disclosure. The apparatus 805 may be a UE.

The processing system 810 may be implemented with a bus architecture, represented generally by the bus 815. The bus 815 may include any number of interconnecting buses and bridges depending on the specific application of the processing system 810 and the overall design constraints. The bus 815 links together various circuits including one or more processors and/or hardware components, represented by the processor 820, the illustrated components, and the computer-readable medium/memory 825. The bus 815 may also link various other circuits, such as timing sources, peripherals, voltage regulators, and/or power management circuits.

The processing system 810 may be coupled to a transceiver 830. The transceiver 830 is coupled to one or more antennas 835. The transceiver 830 provides a means for communicating with various other apparatuses over a transmission medium. The transceiver 830 receives a signal from the one or more antennas 835, extracts information from the received signal, and provides the extracted information to the processing system 810, specifically the reception component 702. In addition, the transceiver 830 receives information from the processing system 810, specifically the transmission component 704, and generates a signal to be applied to the one or more antennas 835 based at least in part on the received information.

The processing system 810 includes a processor 820 coupled to a computer-readable medium/memory 825. The processor 820 is responsible for general processing, including the execution of software stored on the computer-readable medium/memory 825. The software, when executed by the processor 820, causes the processing system 810 to perform the various functions described herein for any particular apparatus. The computer-readable medium/memory 825 may also be used for storing data that is manipulated by the processor 820 when executing software. The processing system further includes at least one of the illustrated components. The components may be software modules running in the processor 820, resident/stored in the computer readable medium/memory 825, one or more hardware modules coupled to the processor 820, or some combination thereof.

In some aspects, the processing system 810 may be a component of the UE 120 and may include the memory 282 and/or at least one of the TX MIMO processor 266, the RX processor 258, and/or the controller/processor 280. In some aspects, the apparatus 805 for wireless communication includes means for receiving sensor data or other data associated with identifying a characteristic associated with a mobility scenario; and means for performing at least a portion of a cell selection procedure based at least in part on the characteristic associated with the mobility scenario. Additionally, or alternatively, the apparatus 805 may include means for predicting that a cell selection is to occur within a threshold period of time based at least in part on the sensor data; means for updating, based at least in part on performing the at least the portion of the cell selection procedure, at least one of a UE location or one or more parameters associated with the UE location; means for identifying a UE location or a set of candidate UE locations based at least in part on the sensor data; means for acquiring a set of satellites, wherein a threshold quantity of satellites is associated with a determination of the UE location, wherein a quantity of satellites in the acquired set of satellites is less than the threshold quantity; means for predicting the UE location using the acquired set of satellites; means for acquiring a plurality of satellites in a sequence; means for predicting the UE location based at least in part on an order of acquisition of the plurality of satellites acquired in the sequence; and/or means for predicting the UE location based at least in part on flight data. The aforementioned means may be one or more of the aforementioned components of the apparatus 700 and/or the processing system 810 of the apparatus 805 configured to perform the functions recited by the aforementioned means. As described elsewhere herein, the processing system 810 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 8 is provided as an example. Other examples may differ from what is described in connection with FIG. 8.

The following provides an overview of some Aspects of the present disclosure:

Aspect 1: A method of wireless communication performed by a user equipment (UE), comprising: receiving sensor data or other data associated with identifying a characteristic associated with a mobility scenario; and performing at least a portion of a cell selection procedure based at least in part on the characteristic associated with the mobility scenario.

Aspect 2: The method of Aspect 1, wherein performing the at least the portion of the cell selection procedure comprises: performing a receive-based frequency or band search portion of the cell selection procedure.

Aspect 3: The method of any of Aspects 1-2, wherein the sensor data includes information identifying a descent phase or a landing phase associated with an aircraft in which the UE is located.

Aspect 4: The method of Aspect 3, wherein the sensor data includes information identifying: a set of pre-landing turns, a landing gear extension, a touchdown vibration, or a cabin pressure change.

Aspect 5: The method of any of Aspects 1-4, wherein receiving the sensor data comprises: receiving the sensor data during an airplane mode of the UE.

Aspect 6: The method of any of Aspects 1-5, further comprising: predicting that a cell selection is to occur within a threshold period of time based at least in part on the sensor data; and wherein performing the at least the portion of the cell selection procedure comprises: performing the at least the portion of the cell selection procedure based at least in part on the predicting that the cell selection is to occur.

Aspect 7: The method of Aspect 6, wherein the predicting that the cell selection is to occur is based at least in part on whether information identifying a UE location is available and a mapping of the UE location to an associated set of available cells.

Aspect 8: The method of any of Aspects 1-7, wherein the sensor data includes information identifying a change of location of the UE.

Aspect 9: The method of any of Aspects 1-8, further comprising: updating, based at least in part on performing the at least the portion of the cell selection procedure, at least one of a UE location or one or more parameters associated with the UE location.

Aspect 10: The method of Aspect 9, wherein the one or more parameters include at least one of: a UE clock time zone, a communication satellite beam information, a magnetic compass declination, or a country level seed position for signal searching.

Aspect 11: The method of any of Aspects 1-10, further comprising: identifying a UE location or a set of candidate UE locations based at least in part on the sensor data; and wherein performing the at least the portion of the cell selection procedure comprises: performing the at least the portion of the cell selection procedure using a prioritized list of bands, the prioritized list of bands being based at least in part on the UE location or the set of UE locations.

Aspect 12: The method of Aspect 11, wherein the UE location or the set of candidate UE locations is based at least in part on at least one of: data associated with a Wi-Fi connection, a barometric pressure, a temperature, a travel duration, a travel distance, a departure location, or a heading.

Aspect 13: The method of Aspect 11, further comprising: acquiring a set of satellites, wherein a threshold quantity of satellites is associated with a determination of the UE location, wherein a quantity of satellites in the acquired set of satellites is less than the threshold quantity; and predicting the UE location using the acquired set of satellites.

Aspect 14: The method of Aspect 11, further comprising: acquiring a plurality of satellites in a sequence; and predicting the UE location based at least in part on an order of acquisition of the plurality of satellites acquired in the sequence.

Aspect 15: The method of Aspect 11, further comprising: predicting the UE location based at least in part on flight data.

Aspect 16: The method of any of Aspects 1-15, wherein the sensor data is from a plurality of sensors of the UE.

Aspect 17: The method of any of Aspects 1-16, wherein the sensor data includes data from a satellite, the satellite including a navigation system satellite.

Aspect 18: An apparatus for wireless communication at a device, comprising a processor; memory coupled with the processor; and instructions stored in the memory and executable by the processor to cause the apparatus to perform the method of one or more of Aspects 1-17.

Aspect 19: A device for wireless communication, comprising a memory and one or more processors coupled to the memory, the one or more processors configured to perform the method of one or more of Aspects 1-17.

Aspect 20: An apparatus for wireless communication, comprising at least one means for performing the method of one or more of Aspects 1-17.

Aspect 21: A non-transitory computer-readable medium storing code for wireless communication, the code comprising instructions executable by a processor to perform the method of one or more of Aspects 1-17.

Aspect 22: A non-transitory computer-readable medium storing a set of instructions for wireless communication, the set of instructions comprising one or more instructions that, when executed by one or more processors of a device, cause the device to perform the method of one or more of Aspects 1-17.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c. b+c, and a+b +c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive sensor data or other data associated with identifying a characteristic associated with a mobility scenario; and
perform at least a portion of a cell selection procedure based at least in part on the characteristic associated with the mobility scenario.

2. The UE of claim 1, wherein the one or more processors, to perform the at least the portion of the cell selection procedure, are configured to:
perform a receive-based frequency or band search portion of the cell selection procedure.

3. The UE of claim 1, wherein the sensor data includes information identifying a descent phase or a landing phase associated with an aircraft in which the UE is located.

4. The UE of claim 3, wherein the sensor data includes information identifying:
a set of pre-landing turns,
a landing gear extension,
a touchdown vibration,
a cabin pressure value change, or
a cabin pressure value.

5. The UE of claim 1, wherein the one or more processors, to receive the sensor data, are configured to:
receive the sensor data during an airplane mode of the UE.

6. The UE of claim 1, wherein the one or more processors are further configured to:
predict that a cell selection is to occur within a threshold period of time based at least in part on the sensor data; and
wherein the one or more processors, to perform the at least the portion of the cell selection procedure, are configured to:
perform the at least the portion of the cell selection procedure based at least in part on predicting that the cell selection is to occur.

7. The UE of claim 6, wherein the one or more processors, to predict that the cell selection is to occur within the threshold period of time, are configured to predict that the cell selection is to occur is based at least in part on whether information identifying a UE location is available and a mapping of the UE location to an associated set of available cells.

8. The UE of claim 1, wherein the sensor data includes information identifying a change of location of the UE.

9. The UE of claim 1, wherein the one or more processors are further configured to:
update, based at least in part on performing the at least the portion of the cell selection procedure, at least one of a UE location or one or more parameters associated with the UE location.

10. The UE of claim 9, wherein the one or more parameters include at least one of:
a UE clock time zone,
a communication satellite beam information,
a magnetic compass declination, or
a country level seed position for signal searching.

11. The UE of claim 1, wherein the one or more processors are further configured to:
identify a UE location or a set of candidate UE locations based at least in part on the sensor data; and
wherein the one or more processors, to perform the at least the portion of the cell selection procedure, are configured to:
perform the at least the portion of the cell selection procedure using a prioritized list of bands, the prioritized list of bands being based at least in part on the UE location or the set of UE locations.

12. The UE of claim 11, wherein the UE location or the set of candidate UE locations is based at least in part on at least one of:
data associated with a Wi-Fi connection,
a barometric pressure,
a temperature,
a travel duration,
a travel distance,
a departure location, or
a heading.

13. The UE of claim 11, wherein the one or more processors are further configured to:
acquire a set of satellites, wherein a threshold quantity of satellites is associated with a determination of the UE location, wherein a quantity of satellites in the acquired set of satellites is less than the threshold quantity; and
predict the UE location using the acquired set of satellites.

14. The UE of claim 11, wherein the one or more processors are further configured to:
acquire a plurality of satellites in a sequence; and
predict the UE location based at least in part on an order of acquisition of the plurality of satellites acquired in the sequence.

15. The UE of claim 11, wherein the one or more processors are further configured to:
predict the UE location based at least in part on flight data.

16. The UE of claim 1, wherein the sensor data is from a plurality of sensors of the UE.

17. The UE of claim 1, wherein the sensor data includes data from a satellite, the satellite including a navigation system satellite.

18. A method of wireless communication performed by a user equipment (UE), comprising:
receiving sensor data or other data associated with identifying a characteristic associated with a mobility scenario; and
performing at least a portion of a cell selection procedure based at least in part on the characteristic associated with the mobility scenario.

19. The method of claim 18, wherein performing the at least the portion of the cell selection procedure comprises:
performing a receive-based frequency or band search portion of the cell selection procedure.

20. The method of claim 18, wherein the sensor data includes information identifying a descent phase or a landing phase associated with an aircraft in which the UE is located.

21. The method of claim 20, wherein the sensor data includes information identifying:
a set of pre-landing turns,
a landing gear extension,
a touchdown vibration,
a cabin pressure value change, or
a pressure value.

22. The method of claim 18, wherein receiving the sensor data comprises:
receiving the sensor data during an airplane mode of the UE.

23. The method of claim 18, further comprising:
predicting that a cell selection is to occur within a threshold period of time based at least in part on the sensor data; and
wherein performing the at least the portion of the cell selection procedure comprises:
performing the at least the portion of the cell selection procedure based at least in part on the predicting that the cell selection is to occur.

24. The method of claim 23, comprising occurring is based at least in part on whether information identifying a UE location is available and a mapping of the UE location to an associated set of available cells.

25. The method of claim 18, wherein the sensor data includes information identifying a change of location of the UE.

26. The method of claim 18, further comprising:
updating, based at least in part on performing the at least the portion of the cell selection procedure, at least one of a UE location or one or more parameters associated with the UE location.

27. The method of claim 26, wherein the one or more parameters include at least one of:
a UE clock time zone,
a communication satellite beam information,
a magnetic compass declination, or
a country level seed position for signal searching.

28. The method of claim 18, further comprising:
identifying a UE location or a set of candidate UE locations based at least in part on the sensor data; and
wherein performing the at least the portion of the cell selection procedure comprises:
performing the at least the portion of the cell selection procedure using a prioritized list of bands, the prioritized list of bands being based at least in part on the UE location or the set of UE locations.

29. A non-transitory computer-readable medium storing a set of instructions for wireless communication, the set of instructions comprising:
one or more instructions that, when executed by one or more processors of a user equipment (UE), cause the UE to:
receive sensor data or other data associated with identifying a characteristic associated with a mobility scenario; and
perform at least a portion of a cell selection procedure based at least in part on the characteristic associated with the mobility scenario.

30. An apparatus for wireless communication, comprising:
means for receiving sensor data or other data associated with identifying a characteristic associated with a mobility scenario; and
means for performing at least a portion of a cell selection procedure based at least in part on the characteristic associated with the mobility scenario.
